(19) United States
(12) Patent Application Publication
(10) Pub. No.: US 2002/0015499 A1
(43) Pub. Date: Feb. 7, 2002

(54) Infrabass

(76) Inventor: Stefan Marghuerite Jean Willems, Leuven (BE)

Correspondence Address: U.S. Philips Corporation, 580 White Plains Road, Tarrytown, NY, 10591, US

(21) Appl. No.: 09/904,076

(22) Filed: Jul. 12, 2001

(30) Foreign Application Priority Data
Jul. 13, 2000 (EP) 00202498.2

(51) Int. Cl. H04R 5/00

(52) U.S. Cl. 381/1; 381/98; 381/17

(57) ABSTRACT

To improve the aural sensation of audio signals the use of bandwidth extension devices in audio reproduction systems is known. Herewith it is possible to add a low-pitched signal to the audio signal comprising lower signal part than the original input signal. The invention provides an improvement of the known devices to overcome artifacts in the reproduced audio signal by delaying the unprocessed signal part to obtain the same delay as the obtained sub-harmonics.

The invention relates to a bandwidth extension device.

The invention further relates to an audio reproduction system comprising such a bandwidth extension device.

Such a device is known from the European patent application EP-A-0 240 286.

To improve the aural sensation in low-pitched (this is: signals in the very low frequency band) sound reproduction by an audio reproduction system or the like a sub-harmonics generator is used to create this low-pitched signal. In this way a lower pitch signal is created than is present in the incoming signal.

It is an object of the invention to improve such a bandwidth extension device further.

To this end a first aspect of the invention provide a bandwidth extension device as defined in claim 1. A second aspect of the invention is to provide an audio reproduction system.

The invention is based on the inside that during the creation of the sub-harmonics that part of the signal is delayed longer than the non-processed part of the signal. By combining these two signal parts in the combining means prior art devices have consequently artifacts. By delaying the non-processed signal part it is possible to delay both signal parts equal so overcoming the artifacts the prior art device has.

Embodiments of the invention are described in the dependent claims.

The invention and additional features, which may optimally be used to implement the invention to advantage, will be apparent from and elucidated with a reference to the examples described below and hereinafter and shown in the figures. Herein shows:

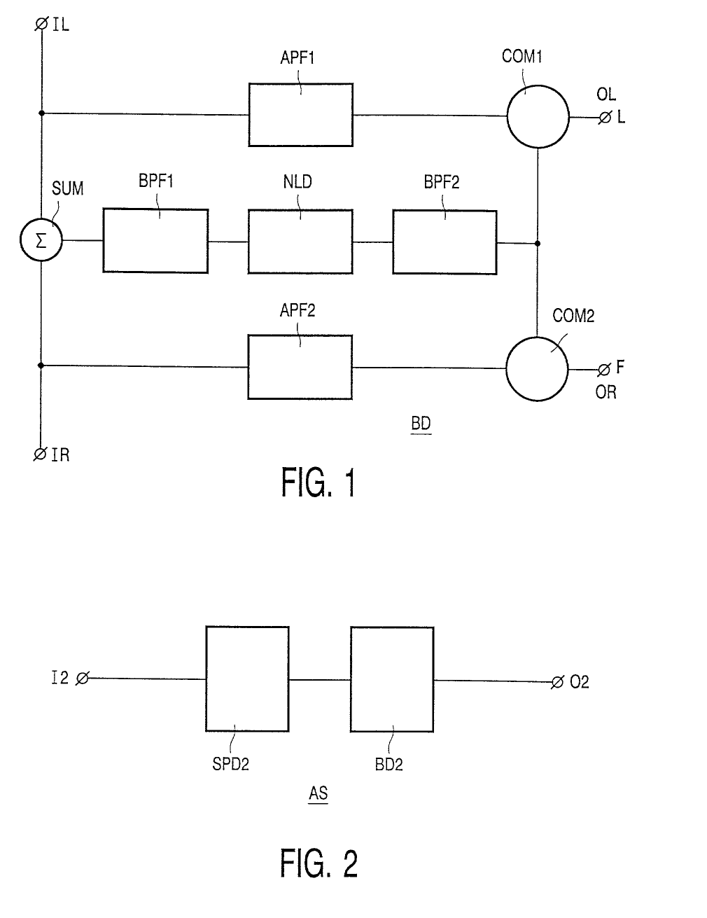

FIG. 1, an example of a bandwidth extension device according to the invention, and

FIG. 2 an example of an audio reproduction system according to the invention.

FIG. 1 shows an example of a bandwidth extension device BD according to the invention.

A bandwidth extension device can be used in an audio reproduction system to improve the aural sensation of the low-pitched signal-part. At a first input IL the device receives a left input signal and at a second input IR the bandwidth extension device receives a right input signal. Both inputs are coupled to a summing device SUM for a summing the both input signals in this example. The output of the summing device is coupled to a band-pass filter BPF1 for filtering the summed input signal to a certain predetermined low frequency part. The output of the band-pass filter BPF1 is coupled to a non-linear device NLD for creating an adapted signal with a low frequency part. Herewith sub-harmonics of the lowest part of the input signal are created, resulting in a lower pitch signal than is present in the incoming signal.

Reference is made to the non-prepublished European application of the same applicant EP application ref. Nr. 00201509.7 (applicants ref. PHNL000249) wherein the use of sub-harmonics generators is described in detail.

The output of the non-linear NLD is coupled to a second band-pass filter BPF2 for filtering out the non-required frequency part. The output of the band-pass filter BPF2 is coupled to a first combining device COM1 and to a second combining device COM2.

The first combining device COM1 receives at a second input a signal from an all-pass filter APF1 which all-pass filter is coupled with its input to the first input of the bandwidth extension device IL. The second combining device COM2 receives a the other input a signal from a second all-pass filter APF2 which receives at its input a signal from the second input IR of the bandwidth extension device. The output of the first and second combining device COM1 respectively COM2 are coupled to the first and second output of the bandwidth extension device OL respectively OR.

By adding the all-pass filter APF1 and the all-pass filter APF2 having a certain delay it is made possible to combine in the combining devices the two signal parts with the same delay. This results in an improved output signal in comparison with prior art devices.

Instead of the all-pass filters is also possible to use a delay element. Further it is possible to use a controllable delay element which makes it possible to amend the delay in dependence of the delay of the signal path through the band-pass filter BPF1, the non-linear device NLD and the band-pass filter BPF2.

1. A band-pass extension device comprising an input for receiving an input signal, a first signal path and a second signal path whereby the first signal path comprises a filter means for filtering the input signal, creating means for creating an adapted signal with a lower frequency part than the input signal, combining means for combining the adapted signal of the first signal path with the input signal of the second signal path whereby the second signal path comprises between the input and the combining means delay means.

2. A bandwidth extension device as claimed in claim 1, characterized in that the delay means comprise filter means.

3. A bandwidth extension device as claimed in claim 1, characterized in that the delay of the delay means is controllable.

4. An audio reproduction system comprising a bandwidth extension device as claimed in claim 1.
